(19) United States
(12) Patent Application Publication
(10) Pub. No.: US 2002/0154933 A1
(43) Pub. Date: Oct. 24, 2002

(54) Print medium for a label printer

(76) Inventor: Stephen R. Kalette, Shaker Heights, OH (US)

Correspondence Address: David N. Fronek, DORSEY & WHITNEY LLP, Suite 1500, 50 South Sixth Street, Minneapolis, MN, 55402-1498, US

(21) Appl. No.: 10/055,867

(22) Filed: Jan. 23, 2002

Related U.S. Application Data
(60) Provisional application No. 60/263,919, filed on Jan. 24, 2001.

(51) Int. Cl. B41J 11/26

(52) U.S. Cl. 400/615.2; 400/120.01

(57) ABSTRACT

A print medium for use in labeling wire, cable and other similarly configured products being in the form of a continuous tape having a print surface with an opaque portion and a transparent or translucent portion and an opposite connection surface.

This application claims the benefit of Provisional Application Serial No.60/263,919 filed Jan. 24, 2001.

### BACKGROUND OF THE INVENTION

1. Field of the Invention

The present invention relates generally to a print medium for a label printer and more specifically to a continuous tape usable in a label printer for use as a wire wrap or as a means to mark wire, cable or other difficult to label products.

2. Description of the Prior Art

A variety of portable printers or labelers currently exist in the art. These are exemplified by U.S. Pat. No. 4,815,875, U.S. Pat. No. 4,966,476, U.S. Pat. No. 5,022,771, U.S. Pat. No. 4,815,875, U.S. Pat. Nos. 4,966,476 and 5,022,771, the disclosures of all of these being incorporated herein by reference. These printers or labeling devices print on a roll of tape which is either clear or opaque for the purpose of preparing labels and the like.

The above printers and labeling devices are what are commonly referred to as cartridge based systems in which the supply of tape or other print medium is contained within a replaceable cartridge. An example of a cartridge for a cartridge based system is shown in U.S. Pat. No. 5,653,542, the disclosure of which is incorporated herein by reference.

The labeling of wires, cables and other similar products which are elongated or of continuous length with a relatively small diameter or other cross-sectional configuration are difficult to label. Current products used for labeling wires, cables and the like include tubing such as shrink tube, die cut labels in which a portion of the label is opaque and a portion translucent. Conventional opaque and clear tape have also been used in some cases, to mark or label these products.

There is a continuing need, however, for improved labeling products to meet the need for labeling wires, cables and other similarly configured products.

### SUMMARY OF THE INVENTION

The present invention relates to a unique print medium for use in labeling wire, cable and other similarly configured products.

More specifically, the present invention is directed to a print medium for use in a label printer of the type having a thermal print head and a platen roller defining a print station. Preferably, the label or printer is a cartridge based system in which the print medium is provided in a replaceable cartridge in rolled form.

In the preferred embodiment of the present invention, the print medium comprises an elongated, continuous tape in which the tape includes a first or print surface, an opposite second surface and a pair of generally parallel side edges. In the preferred embodiment, the print surface is continuous throughout the length of the tape and includes an opaque portion and a transparent or translucent portion or a plurality of opaque portions and a plurality of transparent or translucent portions.

In variations of this embodiment, the opaque and transparent/translucent portions can be separated longitudinally relative to the tape along a line positioned between the edges and extending generally parallel to the side edges of the tape. In another embodiment, the tape can be comprised of a plurality of opaque portions and a plurality of transparent or translucent portions which are positioned along the tape in alternating fashion, with such portions being separated along a line generally perpendicular to the side edges of the tape.

In a still further embodiment, the tape with opaque and transparent/translucent portions can be part of a combination of tapes which together provide a label for marking or identifying wire, cable or other similarly configured products.

Accordingly, it is an object of the present invention to provide a print medium for use in marking or labeling wires, cables or other similarly configured products.

Another object of the present invention is to provide a new print medium for a cartridge based system.

A still further object of the present invention is to provide a print medium for a cartridge based system having a continuous non-cut print surface in which such print surface comprises opaque portions and transparent or translucent sections.

These and other embodiments will be apparent with reference to the drawings, the description of the preferred embodiment and the appended claims.

### DESCRIPTION OF THE DRAWINGS

FIG. 1 is an isometric view of a section of a print medium in accordance with the present invention.

FIG. 2 is an isometric view of a further embodiment of a print medium in accordance with the present invention.

FIG. 3 is a side elevational view of a print medium in accordance with the present invention in roll form.

FIG. 4 is an elevational plan view of a further embodiment of the print medium type shown in FIG. 1.

FIG. 5 is an elevational plan view of a further embodiment of the print medium of the type shown in FIG. 1.

FIG. 6 is an elevational plan view of a further embodiment of the print medium of the type shown in FIG. 2.

FIG. 7 is an elevational plan view of a further embodiment of the print medium of the type shown in FIG. 2.

FIG. 8 is a view, partially in section, as viewed along the section line 8-8 of FIG. 4.

FIG. 9 is a view, partially in section, as viewed along the section line 9-9 of FIG. 6.

FIG. 10 is a view, partially in section, showing application to a wire of a label from the tape of any of the embodiments in FIGS. 1-9.

FIG. 11 is an isometric view of a label produced from a tape of any of the embodiments of FIGS. 1-9 applied to a wire.

FIG. 12 is an exploded, isometric view of a further embodiment of a tape combination in accordance with the present invention for labeling wire, cable or the like.

FIG. 13 is a view, partially in section, of the tape combination of FIG. 12.

FIG. 14 is a view, partially in section, showing application to a wire of a label formed from the tape combination of FIGS. 12 and 13.

FIG. 15 is an elevational plan view of a cartridge (with one side removed) for a cartridge based system containing the tape combination elements of FIGS. 12 and 13.

### DESCRIPTION OF THE PREFERRED EMBODIMENT

The present invention is directed to a unique print medium in the form of a tape in rolled form. The print medium of the present invention has specific application for use in marking wires, cables and other products of similar configuration and has special application for use in a replaceable cartridge for a cartridge based system.

FIG. 1 shows a first embodiment of the print medium in accordance with the present invention. Specifically, the embodiment of FIG. 1 comprises a tape 10 having a top or first surface 11 and a second, non-print surface 12 which is opposite to the surface 11. The tape 10 of FIG. 1 also includes a pair of side edges 14 and 15 which are generally parallel to one another.

As shown in FIG. 1, the print surface 11 includes a print portion 16 and a non-print portion 18. In the preferred embodiment, the print portion 16 is opaque or substantially opaque, while the non-print portion 18 is transparent or translucent. In the embodiment of FIG. 1, the opaque portion 16 and the transparent or translucent portion 18 are adjacent to one another along a line 21 which is positioned between the side edges 14 and 15 and extends generally parallel to the side edges 14 and 15 along the length of the tape 10. The print portion 16 is designed to receive print or other indicia 19 from the label printer. This is accomplished by thermal or thermal transfer printers that are well known and available in the art. Examples of such printers or labeling devices include the Brother P-Touch series of printers which include TZ, TC or TX style tape or print medium cartridges and the Kroy 2500 series printers or labeling devices. These labeling devices are well known in the art and their disclosure is incorporated herein by reference.

The tape 10 of FIG. 1 has a continuous length and is designed to be selectively cut by the user along cut lines such as that shown by the reference character 20. These cut lines 20 are determined by the user, depending upon the length of the print medium or label desired or depending upon the length of print media necessary to receive the indicia 19.

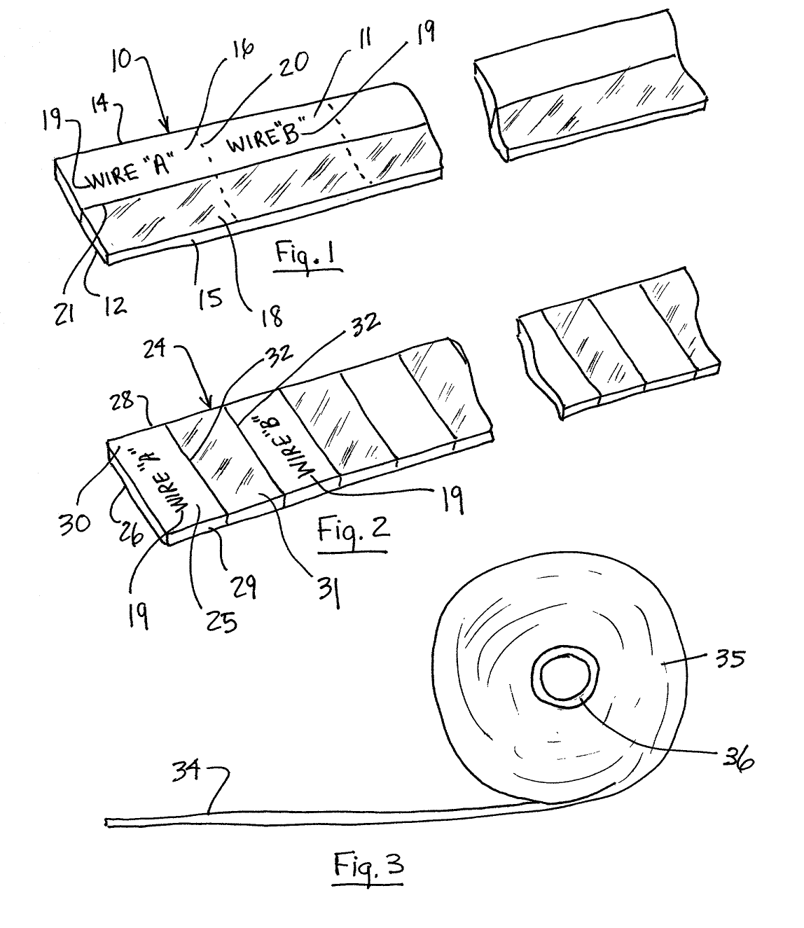

The embodiment of FIG. 2 comprises a tape 24 which also includes a top or first surface 25 and a second, non-print surface 26 which is opposite to the surface 25. The tape 24, like the tape 10 of FIG. 1, includes a pair of generally parallel side edges 28 and 29. The top or print surface 25 of the tape 24 includes a print portion 30 and a non-print portion 31. In the preferred embodiment of FIG. 2, the print portion 30 is opaque or substantially opaque, while the non-print portion 31 is transparent or translucent. The print portion 30 is designed to receive print or other indicia 19 from a printer or label device of the type described above.

In both of the embodiments of FIGS. 1 and 2, the tapes 10 and 24 are comprised of tapes that have a generally continuous print surface. In other words, the top surfaces 11 and 25, respectively, of these tapes are not die cut. Further, the tapes 10 and 24 of FIGS. 1 and 2 are preferably provided in roll form as shown in FIG. 3. Such tapes may then be provided in a cartridge based system in such rolled form. As shown, the tape provided in rolled form includes a leading or free end 34, a rolled portion 35 and an internal, centrally positioned hub 36 for mounting in a print medium supply cartridge such as that shown in FIG. 15. Such cartridges are known in the art and may include any of the cartridges designed for use with the above-mentioned printers or labeling devices including, among others, any of the Brother TZ, TC or TX style cartridges, and any of the Kroy supply cartridges designed for use with the Kroy 2500 series printer.

The print or opaque portions 30 and the non-print transparent or opaque portions 31 of the tape 24 are provided along the length of the tape 24 at spaced intervals. Thus, in the embodiment of FIG. 2, the opaque portions 30 and the transparent/translucent portions 31 are adjacent to one another along the lines 32 which are generally perpendicular to the side edges 28 and 29. These lines 32,32 separating adjacent opaque or print portions 30 from transparent/translucent portions 31 also define cut lines for the tape 24. The cutting of the tape 24 along these cut lines 32 can be done manually by the operator or automatically as a result of indexing or registration marks within the tape that are detected by the printer.

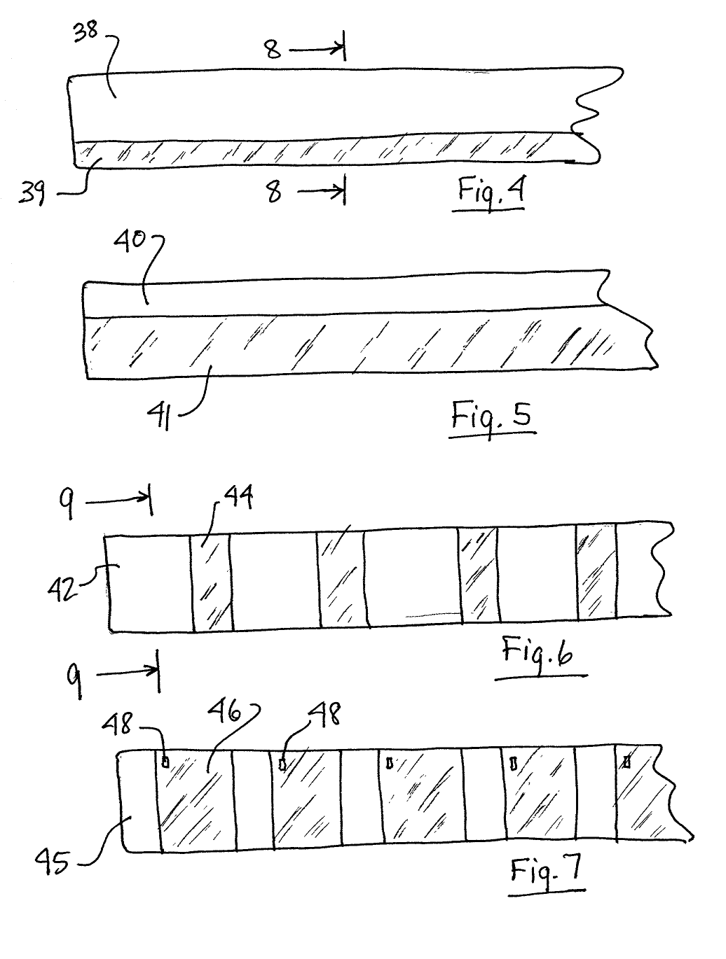

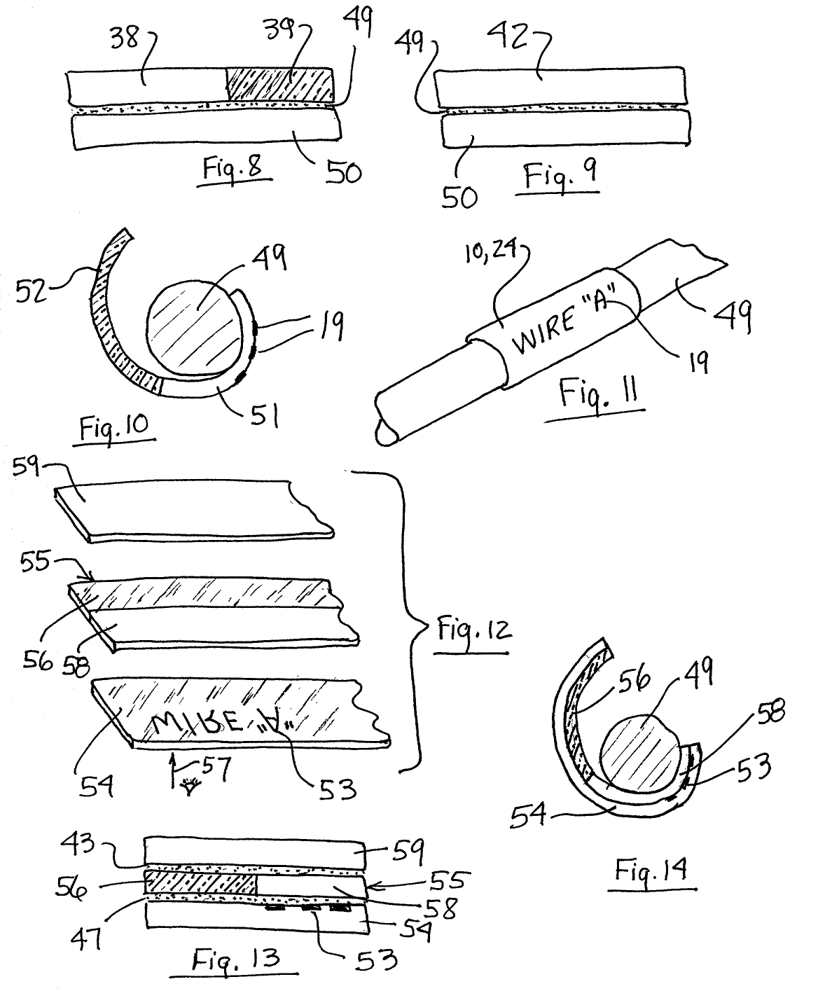

FIGS. 4 and 5 show alternative embodiments for a tape construction with longitudinally separated opaque and transparent/translucent areas such as those shown in the embodiment of FIG. 1. While the opaque and translucent/translucent areas in the embodiment of FIG. 1 have a generally equal width, in FIGS. 4 and 5 they are not. Specifically, in FIG. 4, the opaque area 38 is wider than the transparent/translucent area 39, while in FIG. 5, the opaque area 40 is narrower than the transparent/translucent area 41.

FIGS. 6 and 7 show variations of the embodiment of FIG. 2. Specifically, in FIG. 6, the opaque areas 42 are wider than the transparent/translucent areas 44, while in FIG. 7, the opaque areas 45 are narrower than the transparent/translucent areas 46. Further, the tape in FIG. 7 is shown as being provided with indexing or registration marks or indicia 48,48 for the purpose of triggering the print mechanism in the printer. It is contemplated that such indexing or registration marks 48 would permit the printer to cut the tape of the embodiments of FIGS. 2, 6 and 7 only along the predesignated cut lines 32 which separate one print combination of an opaque area and a transparent/translucent area from another.

The cross-sectional configuration of the tapes of the embodiments of FIGS. 1 and 2 and their respective variations are shown in FIGS. 8 and 9. Specifically, FIG. 8 is a sectional view of the tape shown in FIG. 4. In this embodiment, the bottom surface of the tape is provided with an adhesive layer 49 which is in turn provided with a release layer 50.

Similarly, as shown in FIG. 9, which is a cross section of the tape of FIG. 6, the bottom surface of the tape is provided with an adhesive layer 49 which is in turn provided with a release layer 50. With this structure, the tape which exits the cartridge, with print or label indicia thereon, can be applied to a desired substrate or wrapped around a wire, cable or the like by first removing the release layer 50 and then applying the adhesive surface to such substrate, wire, cable or the like.

After the tape has received the desired indicia from the printer or labeling device, it is cut by means known in the art, thereby resulting in a label which can be applied to a substrate or other surface. FIG. 10 illustrates the application of such a label to a wire 49. After the release layer 50 is removed from the label, the adhesive backed tape (10 or 24) is applied to the wire as shown. The opaque portion 51 of the label with the print indicia 19 thereon is first applied to the wire as shown. Then the label is wrapped around so that the transparent/translucent portion 52 overlaps the portion 51 or at least that portion which includes the print indicia 19. This provides a lamination to the print indicia 19. The labeled wire, after the label has been applied is shown in FIG. 11.

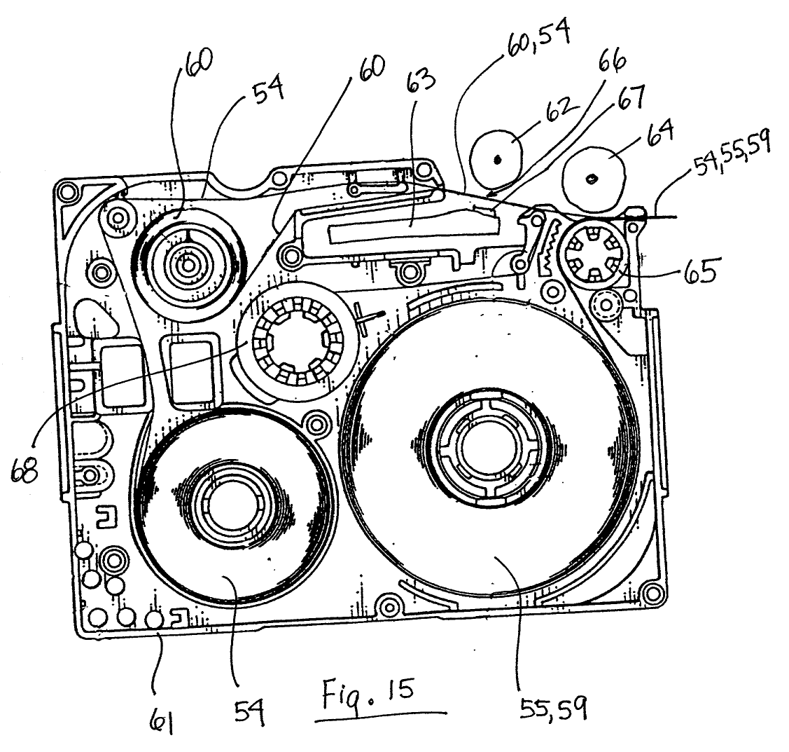

A further embodiment of a print medium in accordance with the present invention is shown in FIGS. 12 and 13 as a print medium comprising a combination of tapes. Specifically, the combination of this embodiment includes a tape 54 designed to receive indicia, a lamination tape layer 55 and a release layer 59. In this embodiment, the print receiving tape 54 is transparent or translucent and is designed for receiving indicia 53 on its print surface. Further, the indicia 53 is printed in mirror image form because it is intended to be read or viewed from the surface of the tape 54 opposite the print surface. Thus, the indicia 53 is viewed through the transparent/translucent tape 54 from the direction 57.

A second tape in the tape combination of FIG. 12 is the lamination tape 55 which includes an opaque portion 58 and a transparent or translucent portion 56. As shown in FIG. 13, the bottom surface of the tape 55 is provided with an adhesive 47 so that it can be selectively secured to the top surface of the tape 54 after the print indicia 53 has been applied. The top surface of the tape 55 is provided with an adhesive layer as well which is in turn covered by the release layer 59. With this tape combination structure, a wire, cable or the like labeling means can be provided. Such a tape combination is useful in known printers or labeling devices such as the Brother line of P-touch printers and labeling devices which accept a TZ, TC or TX style cartridge. The application of this tape combination to such printers, however, is not intended to be limited to these specific printers.

With such tape combination, the printer prints an indicia 53 on the tape supply 54 provided in a cartridge in rolled form. This indicia 53 is printed in mirror image form. Following such printing, the tape 55 which is also provided in the cartridge in rolled form is laminated over the printed surface of the tape 54. The tape 55 has opaque 58 and transparent/translucent 56 portions, with the opaque portion 58 overlapping or being secured to the tape 54 in the area which receives the printed indicia 53.

FIG. 15 is a view of a tape supply cartridge for use in a cartridge based system containing tape supplies for producing the tape combination shown in FIGS. 12, 13 and 14. Specifically, the cartridge of FIG. 15 includes a cartridge housing 61 and associated structure known in the art. The cartridge contains a supply of the transparent or translucent tape 54, a supply of the tape combination 55 and 59 and a ribbon supply 60 for printing indicia onto the tape 54. As shown, the tape 54 is guided through the cartridge via a plurality of rollers and/or guides to a print station 66. Shortly before the print station 66, the tape 54 is joined in overlapping relationship with the ribbon supply 60. The print station 66 is defined as the area between the print head 67 and the platen roller 62. The print head 67 is supported by the print head support 63. At the print station 66, as a result of heat and pressure between the roller 62 and the print head 67, indicia is transferred from the ribbon 62 to the print surface of the tape 54.

After passing the print station 66, the ribbon 60 is directed to a ribbon take-up spool 68 and the tape 54, with the indicia thereon, is directed to a laminating station between the pair of rollers 64 and 65. At this point, the combined tapes 55,59 with the adhesive surface 47 (FIG. 13) facing the tape 54 is brought into engagement with the printed surface of the tape 54. This produces a laminated tape 54,55,59 of the type shown in the sectional view of FIG. 13 as it exits the cartridge.

To apply a label produced from the tape combination of FIGS. 12 and 13 as dispensed from the cartridge shown in FIG. 15, the release layer 59 is removed from the top surface of the tape 55 to expose the top adhesive layer 43 of the tape 55. The tape combination 54,55, with the adhesive layer 43 exposed, is then applied to the outer surface of a wire, cable or the like 49 as shown in FIG. 14. The label is then wrapped around as shown, with a portion of the transparent/translucent tape 54 and the transparent/translucent portion 56 of the tape 55 being wrapped around and overlapping the printed indicia 53.

Although the description of the preferred embodiment has been quite specific, it is contemplated that various modifications could be made without deviating from the spirit of the present invention. Accordingly, it is intended that the scope of the present invention be dictated by the appended claims rather than by a description of the preferred embodiment.

1. A print medium for use in a label printer of the type having a thermal print head and a platen roller defining a print station, said print medium comprising:
an elongated continuous tape;
said tape having a first surface, an opposite second surface and a pair of generally parallel side edges, one of said first and second surfaces being a continuous print surface; and
said print surface having an opaque portion and one of a transparent or translucent portion.

2. The print medium of claim 1 wherein said tape is in rolled form.

3. The print medium of claim 1 wherein said print surface includes a print portion and a non-print portion.

4. The print medium of claim 3 wherein said print portion is said opaque portion and said non-print portion is said one transparent or translucent portion.

5. The print medium of claim 1 wherein said opaque portion and said one transparent or translucent portion are adjacent to one another along a line positioned between, and extending generally parallel to, said side edges.

6. The print medium of claim 1 including a plurality of opaque portions at spaced intervals along said tape and a plurality of said one transparent or translucent portions at spaced intervals along said tape, wherein said opaque portions and said one transparent or translucent portions alternate along the length of said tape.

7. The print medium of claim 6 wherein said plurality of alternating opaque portions and said plurality of said one transparent or translucent portions are adjacent to each other along lines generally perpendicular to said side edges.

8. The print medium of claim 1 wherein said tape comprises a multiple layers between said first surface and said second surface.

9. The print medium of claim 8 including a print layer comprising said print surface and an opposite adhesive surface.

10. The print medium of claim 9 including a release layer comprising a release surface adjacent to said adhesive surface.

11. A cartridge for a cartridge based labeling system, said cartridge containing a supply of print medium in rolled form wherein said print medium comprises:
an elongated continuous tape;
said tape having a first surface, an opposite second surface and a pair of generally parallel side edges, one of said first and second surfaces being a continuous print surface; and
said print surface having an opaque portion and one of a transparent or translucent portion.

12. The print medium of claim 6 including registration marks along the length of said tape.

13. The print medium of claim 12 wherein said registration marks are print and cut registration marks.

14. A tape combination for a cartridge based label system comprising:
a first tape being transparent or translucent and having a print surface adapted to receive print indicia and
a second tape having a first adhesive surface and a second opposite adhesive surface adapted for securement to said print surface of said first tape, said second tape having an opaque portion and a transparent or translucent portion.

15. The tape combination of claim 14 including a release tape releasably secured to said second adhesive surface.

16. The tape combination of claim 15 wherein said opaque portion is aligned with said print indicia when said first adhesive surface is secured to said print surface.

17. The tape combination of claim 14 wherein said first and second tapes are contained in a common cartridge in rolled form.

18. The tape combination of claim 17 including a release tape releasably secured to said second adhesive surface.

19. The tape combination of claim 18 wherein said opaque portion is aligned with said print indicia when said first adhesive surface is secured to said print surface.

20. The tape combination of claim 14 being provided in a cartridge wherein said first tape is provided in rolled form in said cartridge and said second tape is provided in rolled form in said cartridge separate from said first tape.
